(19) United States
(12) Patent Application Publication
(10) Pub. No.: US 2006/0197897 A1
(43) Pub. Date: Sep. 7, 2006

(54) METHOD FOR FORMING DIFFERENT LIQUID CRYSTAL TWIST ANGLE

(75) Inventors: WEI-CHIH CHANG, MIAO-LI COUNTY (TW); DAI-LIANG TING, MIAO-LI COUNTY (TW); JING-YI CHANG, MIAO-LI COUNTY (TW)

Correspondence Address: LOWE HAUPTMAN BERNER, LLP, 1700 DIAGONAL ROAD, SUITE 300, ALEXANDRIA, VA, 22314, US

(73) Assignee: TOPPOLY OPTOELECTRONICS CORP., MIAO-LI COUNTY (TW)

(21) Appl. No.: 11/419,727

(22) Filed: May 22, 2006

Related U.S. Application Data
(62) Division of application No. 10/646,122, filed on Aug. 22, 2003, now Pat. No. 6,936,686.

(30) Foreign Application Priority Data
Sep. 10, 2002 (TW) 91120659

(51) Int. Cl. G02F 1/1335

(52) U.S. Cl. 349/114

(57) ABSTRACT

Different liquid crystal twist angles realize different luminescence efficiencies for reflection and transmission regions, respectively. Therefore, the difference of liquid crystal twist is used in reflection and transmission region, respectively, of a liquid crystal display to maximize their luminescence efficiency so that the total luminescence may reach the optimum state.

### RELATED APPLICATIONS

The present application is a divisional of U.S. patent application Ser. No. 10/656,122, filed Sep. 8, 2003 which is based on, and claims priority from, Taiwanese Application Number 91120659, filed Sep. 10, 2002, the disclosure of which is hereby incorporated by reference herein in its entirety.

### FIELD OF THE INVENTION

The present invention relates to a method of making liquid crystal display (LCD), and more specifically, to a method of using different liquid crystal twist angle in a LCD having both reflection and transmission regions to reach the maximum light efficiency.

### BACKGROUND OF THE INVENTION

Recently, personal digital assistant (PDA) and notebooks have progressed remarkably. Displays for portable use must be light in weight and have low power consumption. Thin film transistor liquid crystal display (TFT-LCD) can meet the above requirements and are known as the display required for high pixel density and quality. In general, a TFT-LCD includes a bottom plate formed with thin film transistors and pixel electrodes and a top plate formed with color filters. The space between the top plate and the bottom plate is filled with liquid crystal. In each unit pixel, a capacitor and a further capacitor are provided; these capacitors are charged and discharged using the TFT as the switching element of the unit pixel. When the data voltage is applied to the TFT, the arrangement of the liquid crystal molecules is changed, thereby changing the optical properties and displaying the image.

Because liquid crystal is not itself luminescent, there are two types, transmission type and reflection type, of LCDs. A transmission type LCD includes an illuminator called a backlight disposed at the rear, which provides a light source. In such a transmission type liquid crystal display device, however, the backlight consumes a large portion of the total power consumed by the liquid crystal display device. Further, in order to improve the display quality in a bright environment, the intensity of the light from the backlight needs to be increased. This further increases the power consumption of the backlight and thus the resultant liquid crystal display device.

In order to overcome the above problem, a reflection type liquid crystal display device has been provided. Such a reflection type liquid crystal display device uses a reflector formed on one of a pair of substrates so that ambient light is reflected from the surface of the reflector. Since the conventional liquid crystal display of the reflection type use the ambient light for the display, the display luminance largely depends on the surrounding environment, and when used under the circumstances where the ambient light is weak, the display content may not be observed. The liquid crystal displays of the reflection type do not use back light for the display, and therefore, have an advantage of saving power.

In order to overcome the above problems, a construction having both a transmission type display and a reflection type display in one liquid crystal display device has been disclosed in U.S. Pat. No. 6,195,140. Such a liquid crystal display device has a different cell gap between the top plate and bottom plate in a transmission region and reflection region to maximize the luminance efficiency.

### SUMMARY OF THE INVENTION

Because differences in liquid crystal twist angle may realize different luminescence efficiencies, the main purpose of the present invention is to provide a manufacture method of liquid crystal display to employ different liquid crystal twist angles in the reflection and transmission regions to maximize the total luminance. The liquid crystal display of the present invention may transmit a part of incident light and reflects the rest so that it can be used when the ambient light is weak while maintaining the advantages of the reflection type liquid crystal display.

The difference of liquid crystal twist angles may result in the different luminescence efficiency for reflection and transmission regions, respectively. Therefore, the difference of liquid crystal twist angles will be respectively used in reflection and transmission regions of a liquid crystal display to maximize their luminescence efficiency. Concave and convex structures are utilized in the lower substrate of the liquid crystal display in accordance with the present invention.

In the first embodiment, a rubbing method is used to arrange the orientation. A rubbing process adjusts and determines the orientation of the orientation layer that may arrange the liquid crystal molecules according to the determined orientation. The present invention uses different rubbing pressures to adjust and determine the orientation of the reflection region and transmission region. A higher rubbing pressure is used to adjust and determine the orientation of the transmission region. At this time, the orientation of the reflection region is also rubbed in the same direction. However, a lower rubbing pressure is used to adjust and determine the orientation of the reflection region. Because the transmission region is located in the recess of the concave and convex structure, it is not rubbed in this step so that the orientation of the transmission region is not changed in this step. In other words, different rubbing pressure is used in this embodiment to arrange the orientation. Both the transmission region and the reflection region can be rubbed when using the higher rubbing pressure. However, only the reflection region can be rubbed when using the lower rubbing pressure. Therefore, there are different orientation arrangements formed on the two regions.

The second embodiment uses UV light to adjust and determine the orientation of the liquid crystal display. This method utilizes UV lights with different polarized direction to illuminate the orientation layer in the transmission region and the reflection region respectively. Accordingly, a UV light with a polarized direction that is same as the required orientation direction is used to illuminate the orientation layer, wherein the UV light source is located above the orientation layer. After illuminating, the transmission region and the reflection region both have the same orientation direction. Next, a UV light with a polarized direction that is same as the required orientation direction of the transmission region is used to illuminate the orientation layer, wherein the UV light is located under the transmission region and reflection region. Accordingly, an orientation layer is formed over the transmission region and the reflection region. Therefore, when the UV light is located above the orientation layer, the whole orientation layer will be arranged. When the UV light is located under the transmission region and reflection region, because the reflection region is composed of an opaque material, the orientation layer located above the reflection layer is not illuminated by the UV light again. As a result, the transmission region and the reflection region have different orientation directions.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a schematic, perspective drawing of a conventional liquid crystal display (LCD).

FIG. 2 is a schematic, cross-sectional drawing of a conventional liquid crystal display (LCD).

FIG. 3 is a schematic, cross-sectional view of a liquid crystal display in accordance with the present invention.

FIG. 4A is a schematic, cross-sectional view of a liquid crystal display, wherein a reflection layer is formed over the transparent conductor layer.

FIG. 4B is a schematic, cross-sectional view of an enlarged region of a liquid crystal display in accordance with the present invention.

FIG. 5 is an orientation arrangement diagram of the orientation layer of the upper substrate in accordance with the present invention.

FIG. 6A and FIG. 6B are orientation arrangement diagrams of the reflection and transmission regions, respectively, in accordance with the present invention.

FIG. 7A and FIG. 7B are schematic, cross-sectional views showing use of differently polarized UV lights to form different orientation arrangement diagrams in the reflection and transmission region according to the present invention.

### DETAILED DESCRIPTION OF THE PREFERRED EMBODIMENT

Without limiting the spirit and scope of the present invention, the method proposed in the present invention is illustrated with one preferred embodiment about a manufacturing method of liquid crystal display. Skilled artisans, upon reviewing the embodiments, can apply the fabricating method according to the present invention to any kind of liquid crystal display having reflection and transmission region to maximize the light-utilization efficiency in the two regions. The method of the present invention transmits part of the incident light and reflects the rest and can be used when the ambient light is weak while maintaining the advantages of the liquid crystal displays of the reflection type. The application of the present invention is not limited by the following embodiment.

The difference in liquid crystal twist angle may cause different luminescence efficiencies for reflection and transmission regions respectively. In accordance with the present invention, different liquid crystal twist angles will be used in reflection and transmission regions respectively to maximize the luminescence efficiency of the liquid crystal display so that the total luminescence may reach the optimum state. In accordance with one embodiment of the present invention, for a liquid crystal display with a 4 μm distance between the upper and lower substrates, when the liquid crystal twist angle is between 70 degrees and 90 degrees, the reflection region has the optimum luminescence efficiency herein, and, when the liquid crystal twist angle is between 10 degrees and 70 degrees, the transmission region has the optimum luminescence efficiency. Therefore, the whole luminescence efficiency of a liquid crystal display will reach the optimum state when the reflection region has a liquid crystal twist angle between 70 degrees and 90 degrees and the transmission region has a liquid crystal twist angle between 10 degrees and 70 degrees.

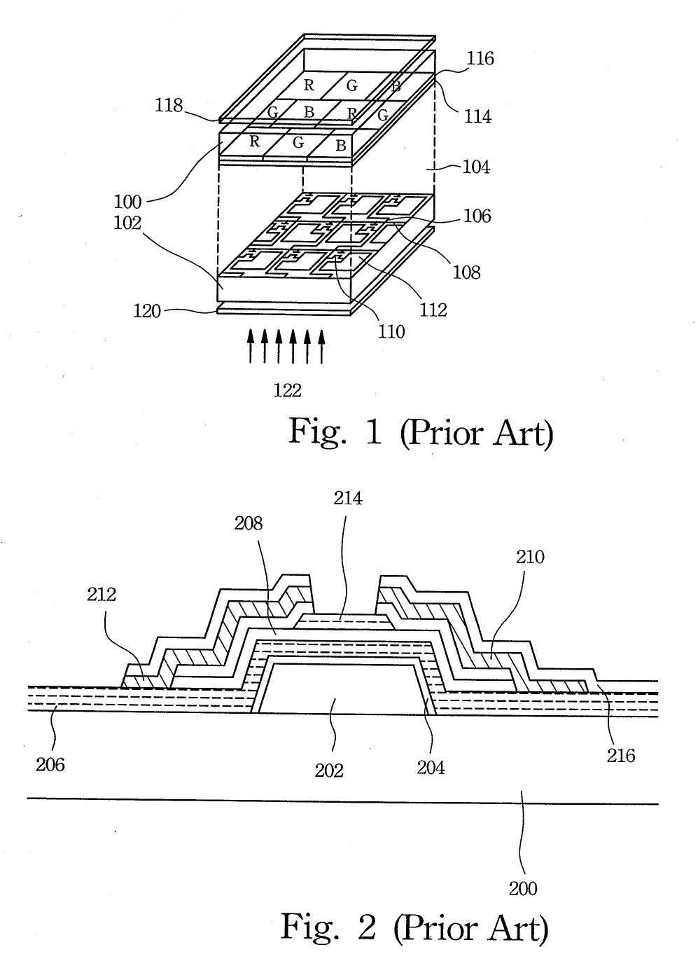

The present invention will now be described in detail with reference to drawings. FIG. 1 shows a schematic drawing of a thin film transistor liquid crystal display (TFT-LCD). The liquid crystal layer 104 is interposed between the upper glass substrate 100 and lower glass substrate 102. The lower glass substrate 102 includes signal line 106 and scan line 108 arranged in a matrix, and in the area defined by the signal line 106 and scan line 108 there is a thin film transistor 110 and a transparent pixel electrode 112. The common electrode 114 and color filter 116 is arranged on the upper glass substrate 100. Then, the liquid crystal display is placed between a pair of light polarizers 118 and 120. When the light 122 is injected into the liquid crystal display, the display will be a transmission type. Each pixel electrode 112 faces a corresponding color filter with red, green or blue color.

FIG. 2 shows a schematic drawing of a thin film transistor used in one embodiment of the present invention. A gate electrode 202 that is sequentially covered with two insulation layers 204 and 206 forms on a glass substrate 200. A channel region 208 fabricated by amorphous silicon material is formed over the insulation layer 206, and a channel protection layer 214 deposited thereon to protect the channel. The drain and source region 210 and 212 fabricated by doped amorphous silicon material located on the both sides. An Indium-Tin-Oxide conductor layer 216 covers the drain and source electrodes 210 and 212 and connects with the pixel electrode (not shown in the figure).

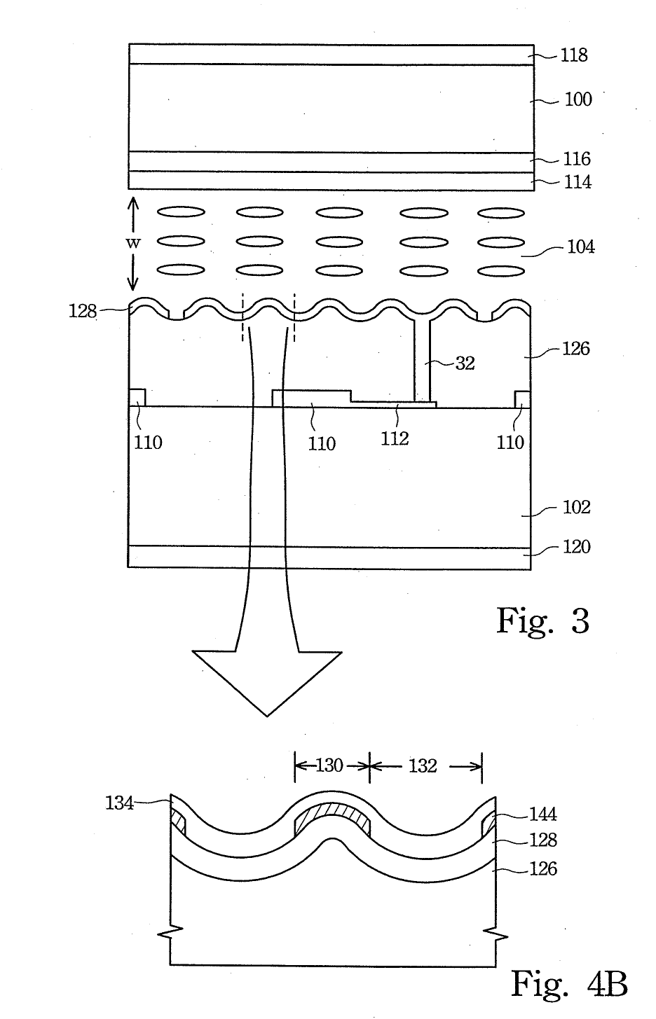

FIG. 3 shows a side view of the liquid crystal display of the present invention. The main difference between FIG. 1 and FIG. 3 is that the thin film transistor 110 in FIG. 3 is covered with an insulation layer 126. A etch process is applied to the insulation layer 126 to form concave and convex surfaces. A transparent Indium-Tin-Oxide conductor layer 128 covers the insulation layer 126 and connects with the pixel electrode 112 of the thin film transistor 110 through a hole 32. The common electrode 114 also composed of the transparent Indium-Tin-Oxide material is formed on the glass substrate 100.

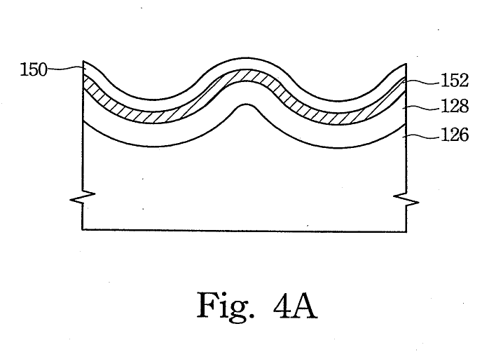

FIG. 4B is an enlarged drawing of FIG. 3 that shows a partial region of transparent conductor layer 128 of the present invention. When both the reflection region and transmission region want to be realized in a pixel, firstly, a reflection layer 152 is formed over the transparent conductor layer 128 as illustrated in the FIG. 4A. The material of reflection layer 152 is Al or Al/Mo alloy. Next, a photoresist 150 is used to define a transmission region in the reflection layer 152. Then, an etching process is performed to form reflection electrode 144 as illustrated in the FIG. 4B. The transparent conductor layer 128 of the transmission region 132 is the transmission electrode. Finally, the photoresist 152 is removed. In accordance with this embodiment, the transmission electrode is located substantially on the concave surface. The defined reflection electrode is substantially located on the convex surface. A plurality of reflection electrodes forms the reflection region of the LCD. The result is shown in FIG. 4B, wherein the block 130 is reflection region and the block 132 is the transmission region. Next, orientation layer 134 is coated on the surfaces of the reflection electrode 144 and the transmission electrode. The orientation layer is also coated on the common electrode 114. In general, the function of the orientation layers is to control the orientation of the liquid crystal molecules. The orientation layer 134 is formed by a polyimide.

In accordance with an embodiment of the present invention, the whole luminescence efficiency of a liquid crystal display with a 4 μm distance between the upper and lower substrate will reach the optimum state when the reflection region has a liquid crystal twist angle between about 70 degrees and 90 degrees and the transmission region has a liquid crystal twist angle between about 10 degrees and 70 degrees. The following is a description of the methods in this invention to arrange the orientation of the liquid crystal twist angle.

Rubbing

The rubbing method is used to arrange the orientation in the first embodiment. The rubbing process adjusts and determines the orientation of the orientation layer that may arrange the liquid crystal molecules according to the determined orientation. The present invention uses different rubbing pressures to adjust and determine the orientation of the reflection region 130 and transmission region 132, as shown in FIG. 4. For example, because the transmission region 132 is located in the recess of the concave and convex structure, the higher rubbing pressure is used to adjust and determine the orientation of this region. The orientation is adjusted and determined in the reflection region 130 and the transmission region 132 at the same time due to the higher rubbing pressure.

Conversely, because the reflection region 130 is located in the convex portion of the concave and convex structure, the lower rubbing pressure is used to adjust and determine the orientation of this region. The transmission region 132 located in the recess of the concave and convex structures is not rubbed in this step because of the lower rubbing pressure so that the orientation of this region is not changed in this step. Therefore, the two regions have different orientations after the two rubbing steps, wherein the transmission region 132 is only rubbed in the first rubbing step but the reflection region 130 is rubbed in the two rubbing steps. However, because of the rubbing characteristic that the latter rubbing step determines the orientation, the second rubbing step dictates the orientation of the reflection region 130. In accordance with the preferred embodiment of the present invention, the rubbing pressure applied to the transmission region 132 at least may rub the lowest portion herein. Conversely, the rubbing pressure applied to the reflection region 130 may not overlap the transmission region 132.

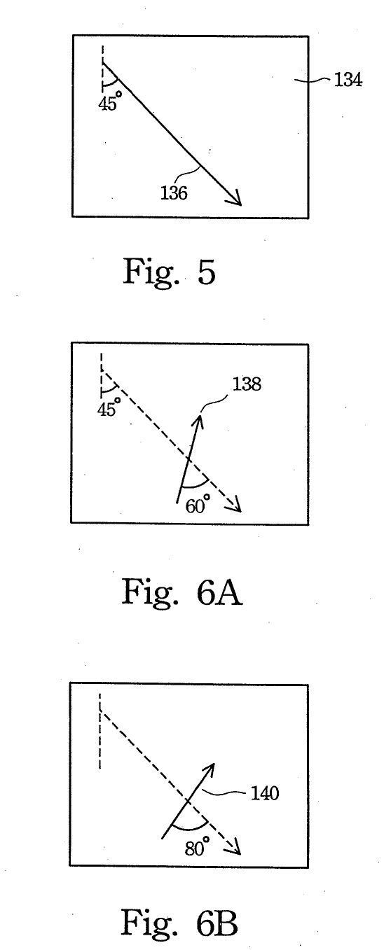

In accordance with the preferred embodiment, a 60-degree liquid crystal twist angle is required in the transmission region 132 and an 80-degree liquid crystal twist angle is required in the reflection region 130. FIG. 5 shows a rubbing direction having a 45-degree angle with the vertical axis applied to the orientation layer 134 over the common electrode 114. FIG. 6A and FIG. 6B respectively show the rubbing direction applied to the orientation layer 134 formed over the reflection region 130 and the transmission region 132. FIG. 6 A is the rubbing of the transmission region 132. Because the transmission region 132 is located in the recession of the concave and convex structure, the higher rubbing pressure is used to identify the orientation of this region. The rubbing pressure applied to the transmission region 132 depends on the depth of the recession. In accordance with the preferred embodiment, the 60-degree liquid crystal twist angle is required in the transmission region 132. The rubbing direction applied to the transmission region 132 is shown in the FIG. 6A indicated by arrow 138. This direction has a 60-degree angle with the rubbing direction (indicated by a dotted arrow) applied to the orientation layer 134 formed over the common electrode 114.

FIG. 6 B shows the orientation arrangement of the reflection region 130. Because the reflection region 130 is located in the convex portion of the concave and convex structure, the lower rubbing pressure is used to identify the orientation of this region. The rubbing pressure applied to the reflection region 130 may not overlap the transmission region 132. Therefore, the transmission region 132 located in the recession of the concave and convex structure is not rubbed in this step. In accordance with the preferred embodiment, the 80-degree liquid crystal twist angle is required in the reflection region 130. The rubbing direction applied to the reflection region 130 is shown in FIG. 6B and indicated by arrow 140. This direction has an 80-degree angle with the rubbing direction (indicated by a dotted arrow) applied to the orientation layer 134 formed over the common electrode 114. Therefore, the reflection region 130 and transmission region 132 have different orientation arrangements after the two rubbing steps. The difference of the liquid crystal twist angle in the two regions may realize the maximum luminescence efficiency.

The rubbing method, evaporation method and UV light alignment method may also be used to arrange the orientation of the orientation layer 134 formed on the common electrode 114.

UV Light

The second embodiment of the present invention uses the UV alignment method. The method uses UV light having an identical polarized direction to arrange the respective orientations of the orientation layers formed over the reflection region 130 and transmission region 132.

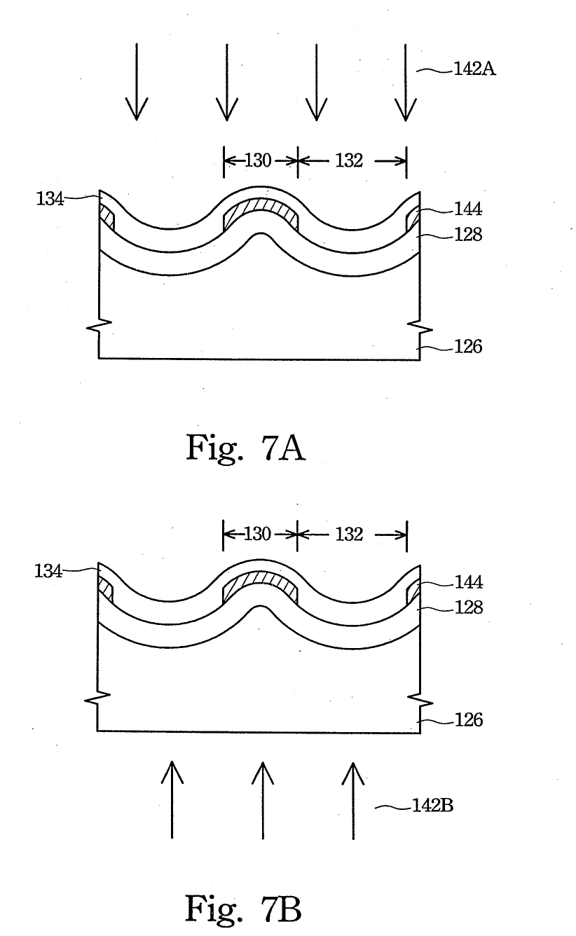

Referring to FIG. 7A, the orientation of the reflection region 130 is first arranged. The UV light 142A having an identical polarized direction as required orientation on the reflection region 130 is used to arrange the orientation of the orientation layer 134. Because the UV light illuminates the whole orientation layer 134, the transmission region 132 and the reflection region 130 have the same arranged orientation.

Referring to FIG. 7B, the orientation of the transmission region 132 is arranged next. The UV light 142B having an identical polarized direction as the required orientation on the transmission region 132 is used from the back to illuminate the orientation layer 134 to arrange the orientation. Although the UV light also illuminates the whole orientation layer 134, it does not illuminate the orientation layer located over the reflection region 130 again due to the reflection region 130 made by opaque material. Only the orientation layer 134 over the reflection region 130 changes the orientation in this step so that the two regions will have the different orientation after the two illumination steps. The reflection region 130 is only illuminated in the first arranged orientation step but the transmission region 132 is illuminated in the two arranged orientation steps. However, because of the characteristic of using UV light to arrange the orientation of the orientation layer, the latter polarized direction of the UV light determines the orientation. After these two orientation arrangement steps, an option step is performed. At this step, a thermal process is performed to fix the orientation arrangement of the orientation layer 134.

In accordance with the second embodiment, the rubbing method, evaporation method and UV light alignment method may also be used to arrange the orientation of the orientation layer 134 formed on the common electrode 114.

Although the invention has been described in detail herein, with reference to its preferred embodiment, it is to be understood that this description is by way of example only, and is not to be interpreted in a limiting sense. It is to be further understood that numerous changes in the details of the embodiments of the invention can occur, and additional embodiments of the invention will be apparent to, and may be made by, persons of ordinary skill in the art having reference to this description. Such changes and additional embodiments fall within the spirit and true scope of the invention as claimed below.

1. A liquid crystal display comprising:
a first substrate;
a second substrate;
a liquid crystal layer interposed between said first substrate and said second substrate;
a pixel region having a reflection region and a transmission region formed over said first substrate;
a continuous wave surface formed over said reflection region and said transmission region;
a reflection electrode formed in said reflection region substantially located in a peak area of said continuous wave surface;
a transmission electrode formed in said transmission region substantially located in a valley area of said continuous wave surface; and
an orientation layer formed over said transmission electrode and said reflection electrode,
wherein said orientation layer formed over said transmission region has a first orientation direction and said orientation layer formed over said reflection region has a second orientation direction, and said first orientation direction is different from said second orientation direction.

2. The liquid crystal display of claim 1, wherein said first orientation direction defines a liquid crystal twist angle between about 10 degrees and 70 degrees in said transmission region.

3. The liquid crystal display of claim 1, wherein said second orientation direction defines a liquid crystal twist angle between about 70 degrees and 90 degrees in said reflection region.

4. The liquid crystal display of claim 1, wherein a first rubbing force is applied to said orientation layer to define said first orientation direction and a second rubbing force is applied to selected regions of said orientation layer to change said first orientation direction in said selected regions to said second orientation direction.

5. The liquid crystal display of claim 4, wherein said first rubbing force is larger than said second rubbing force.

6. The liquid crystal display of claim 1, wherein an UV light with a first polarized direction irradiates said orientation layer to form said first orientation direction.

7. The liquid crystal display of claim 6, wherein said UV light irradiates said orientation layer from back side of said first substrate and utilizes said reflection electrode as a mask.

8. The liquid crystal display of claim 1, wherein an UV light with a second polarized direction irradiates said orientation layer to form said second orientation direction.
